(19) United States
(12) Patent Application Publication
(10) Pub. No.: US 2025/0242737 A1
(43) Pub. Date: Jul. 31, 2025

(54) PIVOTABLE SYSTEM FOR VEHICLE DASHBOARD TO CONTROL VEHICLE FOOT SPACE ACCESS

(71) Applicant: Honda Motor Co., Ltd., Tokyo (JP)

(72) Inventors: DILLON KANE, TORRANCE, CA (US); CHRISTOPHER JOHN TARCHALA, LOS ANGELES, CA (US)

(21) Appl. No.: 18/425,244

(22) Filed: Jan. 29, 2024

(51) Int. Cl. B60N 3/00

(52) U.S. Cl. CPC B60N 3/00

(57) ABSTRACT

A system for a vehicle is provided to control vehicle foot space access. The system includes a pivotable system associated with a dashboard of the vehicle. The pivotable system includes a pivot structure rotatably attached to a pivot point on the dashboard of the vehicle. The pivot structure controls an access to a foot space associated with at least one seat of the vehicle and the foot space corresponds to the dashboard of the vehicle. The pivotable system further includes a rotation control device associated with the pivot point on the dashboard of the vehicle. Further, the rotation control device controls a rotation of the pivot structure about the pivot point.

### BACKGROUND

Among modern means of transposition, a vehicle such as, but not limited, to a car, a truck, or a bus, may be required to meet comfort needs of a user (such as, a driver, or an operator) in addition to the primary purpose of the vehicle for travel. The comfort needs of the user may include a desire to carry and use an object while travelling in the vehicle. Examples of such objects may include, but are not limited to, a computing device, an eatabe item, a lunch box, a wallet and the like. Typically, such vehicle may require attachment of a structure to accommodate the carried objects. The vehicle may be subjected to a jerk due to a sudden change in ride condition of the vehicle, especially, due to change in a road condition or an environmental condition. In some instances, due to the jerk, the carried objects may fall in a foot space, associated with the dashboard of the vehicle. The user may wish to collect the objects from the foot space of the vehicle, which may compromise the driving experience of the user and may also lead to accidents. Moreover, a pet may escape and hide into the foot space, while the vehicle is stationary or in motion. The presence of the pet in the foot space may further distract a driver or a passenger seated in the vehicle.

Limitations and disadvantages of conventional and traditional approaches will become apparent to one of skill in the art, through comparison of described systems with few aspects of the present disclosure, as set forth in the remainder of the present application and with reference to the drawings.

### SUMMARY

According to an embodiment of the disclosure, a system for a vehicle may be provided to control vehicle foot space access. The system may include a pivotable system associated with a dashboard of the vehicle. The pivotable system may include a pivot structure rotatably attached to a pivot point on the dashboard of the vehicle. The pivot structure may be configured to control an access to a foot space associated with at least one seat of the vehicle and the foot space may correspond to the dashboard of the vehicle. The pivotable system may further include a rotation control device associated with the pivot point on the dashboard of the vehicle. Further, rotation control device may be configured to control a rotation of the pivot structure about the pivot point.

According to another embodiment of the disclosure, a vehicle may be provided such that an access to a foot space of the vehicle may be controllable. The vehicle may include a cabin, a dashboard, at least one seat, a foot space associated with the at least one seat and a pivotable system. The pivotable system may include a pivot structure rotatably attached to a pivot point on the dashboard of the vehicle. The pivot structure may be configured to control an access to the foot space associated with the at least one seat of the vehicle and the foot space may correspond to the dashboard of the vehicle. The pivotable system may further include a rotation control device associated with the pivot point on the dashboard of the vehicle. Further, rotation control device may be configured to control a rotation of the pivot structure about the pivot point.

According to another embodiment of the disclosure, a method in a vehicle may be provided to control vehicle foot space access. The method may include attaching a pivotable system to a dashboard of the vehicle. The pivotable system may include a pivot structure rotatably attached to a pivot point on the dashboard. Further, the pivot structure may be configured to control an access to a foot space associated with at least one seat of the vehicle and the foot space may correspond to the dashboard of the vehicle. The pivotable system may further include a rotation control device associated with the pivot point on the dashboard of the vehicle. The rotation control device may be configured to control a rotation of the pivot structure about the pivot point. The method may further include controlling a movement of the pivot structure about the pivot point to change a configuration of the pivotable system.

### BRIEF DESCRIPTION OF THE DRAWINGS

FIG. 1 is a diagram that illustrates an exemplary environment to control access to a foot space associated with a vehicle, in accordance with an embodiment of the disclosure.

FIG. 2 is a block diagram that illustrates an exemplary vehicle system to control access to a foot space associated with a vehicle, in accordance with an embodiment of the disclosure.

FIGS. 3A and 3B are diagrams that collectively illustrate different configurations of a pivot structure to control access to a foot space associated with a vehicle, in accordance with an embodiment of the disclosure.

FIGS. 4A and 4B are scenario diagrams that collectively illustrate configuration of a pivot structure in an un-stowed configuration to control access to a foot space associated with a vehicle, by an embodiment of the disclosure.

FIG. 5 is an exemplary scenario diagram that illustrates a height adjustment and a locking mechanism associated with a pivot structure, in accordance with an embodiment of the disclosure.

FIG. 6 is a flowchart that illustrates an exemplary method to control access to a foot space associated with a vehicle, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Various embodiments of the present disclosure may be found in a system for a vehicle. The disclosed system includes a pivotable system associated with a dashboard of the vehicle. The pivotable system may include a pivot structure rotatably attached to a pivot point on the dashboard of the vehicle. The pivot point may be configured to provide a rotational motion to the pivot structure to place the pivot structure in plurality of configurations, such as, but not limited to, an open configuration, or a closed configuration. The pivot structure may be configured to control an access to a foot space associated with at least one seat of the vehicle, such as, but not limited to, a driver seat or a passenger seat. The foot space may correspond to the dashboard of the vehicle. The pivot structure may control the foot space, which may correspond to the foot space in close proximity of the dashboard in a front cabin of the vehicle, either on a driver side or a passenger side of the vehicle. The pivotable system may further include a rotation control device associated with the pivot point on the dashboard of the vehicle. The rotation control device may be configured to control a rotation of the pivot structure about the pivot point to place the pivot structure in the plurality of configurations.

Traditionally, an in-vehicle structure such as, a flap, a table, or a drawer, associated with the dashboard of the vehicle may be used to accommodate objects carried by a user (such as, a driver, or an operator) inside the vehicle. The in-vehicle structures may be configured to accommodate the carried objects, when the in-vehicle structures may be placed in an opened state, such as, in a horizontal orientation. In the opened state, the in-vehicle structures may obstruct the user or a passenger while boarding the at least one seat of the vehicle. For example, the passenger boarding the passenger seat of the vehicle may face obstruction due to the opened state of the in-vehicle structures, which may accommodate objects carried by the user. In some instances, a jerk experienced by the vehicle, due to a sudden change in ride condition, may force the carried objects to fall in the foot space associated with the vehicle. Moreover, a pet may hide and sit in the foot space, while the vehicle is stationary. Conventionally, the in-vehicle structures may not prevent falling of the carried objects to the foot space associated with the vehicle, which may require repeated collection of the carried objects from the foot space manually by the user or the passenger.

In contrast, the proposed system may control access to the foot space associated with the dashboard of the vehicle, to prevent falling of the carried object to the foot space of the vehicle and may also prevent a pet from hiding in the foot space. For example, the proposed system may place pivot structure in an inclined orientation to block the access to foot space associated with the dashboard of the vehicle. Moreover, the pivot structure may be placed in a stowed configuration to provide access to the foot space for the user, or the passenger boarding the at least one seat of the vehicle. Further, the pivot structure may be adjusted to different heights based on a dimension of the user. For example, in case a child sits on the passenger seat, then the access to foot space (provided by the pivot structure) may be lesser with respect to an adult person sitting on the passenger seat and the height of pivot structure may be adjusted accordingly. Furthermore, the pivot structure may be protracted from the dashboard based on a dimension of the carried objects. For another example, in case an object with a small dimension objects are placed on the pivot structure, a lesser protraction of the pivot structure from the dashboard may be required, and vice versa for larger objects.

Reference will now be made in detail to specific aspects or features, examples of which are illustrated in the accompanying drawings. Wherever possible, corresponding, or similar reference numbers will be used throughout the drawings to refer to the same or corresponding parts.

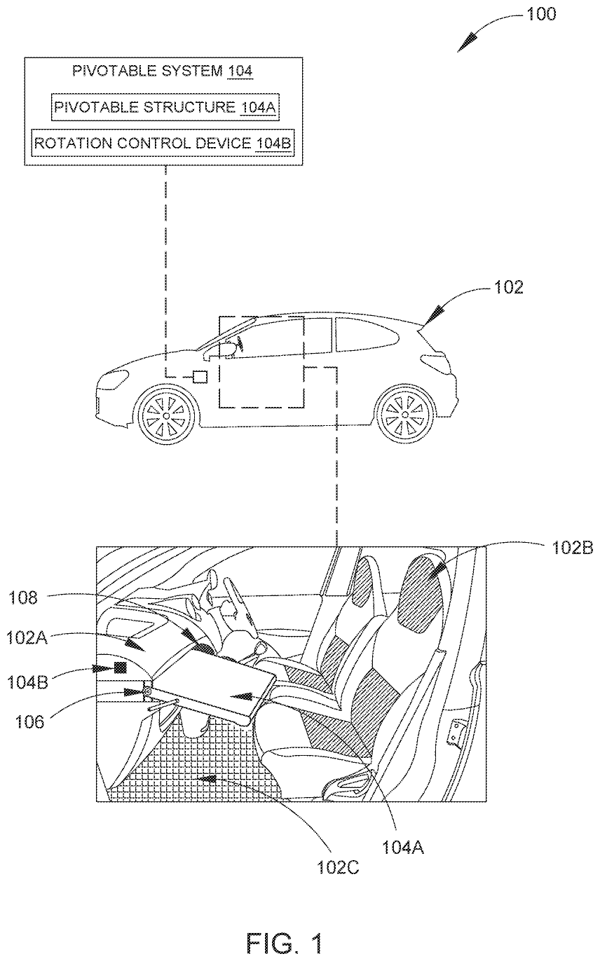

FIG. 1 is a diagram that illustrates an exemplary environment to control access to a foot space associated with a vehicle, in accordance with an embodiment of the disclosure. There is shown a diagram that includes an environment 100. The environment 100 may include a vehicle 102 that has a dashboard 102A, at least one seat 102B, and a foot space 102C. The environment 100 may further include a pivotable system 104 associated with the dashboard 102A of the vehicle 102. The pivotable system 104 may include a pivot structure 104A that may be rotatably attached to a pivot point 106 on the dashboard 102A of the vehicle 102. The pivotable system 104 may further include a rotation control device 104B associated with the pivot point 106 on the dashboard 102A of the vehicle 102. The dashboard 102A of the vehicle may include a slot 108 to accommodate the pivot structure 104A.

The vehicle 102 may be a non-autonomous vehicle, a semi-autonomous vehicle, or a fully autonomous vehicle,. Examples of the vehicle 102 may include, but are not limited to, a three-wheeler vehicle, a four-wheeler vehicle, a hybrid vehicle, or a vehicle with autonomous drive capability that uses one or more distinct renewable or non-renewable power sources. The vehicle 102 may use renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. It should be noted here that the vehicle 102 shown in FIG. 1 is a four-wheeler vehicle, which is merely an example. The present disclosure may be applicable to other types of vehicles (for example, trucks, bus, and the like). The description of such types of the vehicle 102 has been omitted from the disclosure for the sake of brevity. The vehicle may include a cabin (not shown in FIG. 1) which may be physically separated from at least one of an engine compartment (not shown in FIG. 1) or a transmission system (not shown in FIG. 1) of the vehicle 102. The cabin may be referred to as an area designated for a user (such as, a driver, or an operator), or a passenger to sit or drive the vehicle 102. Moreover, the cabin may include a front cabin and a rear cabin (which may be optional). The cabin may further include the dashboard 102A, the at least one seat 102B, and the foot space 102C associated with the vehicle 102.

The dashboard 102A of the vehicle 102 may be a control panel set within a central console of the vehicle 102, usually located in front of the user (such as, a driver, or an operator). The dashboard 102A may display instrumentation and controls for operation of the vehicle 102. The dashboard 102A may include at least one of a speedometer, an odometer, a tachometer, a fuel indicator, turn indicators, or a gearshift position indicator, which may be displayed with a digital readout or a traditional analog gauges. The dashboard 102A may further include comfort and entertainment features such as, but not limited, an air conditioning duct, a music system control panel, a drawer or a table to accommodate carried objects (for example, a computing device, an eatabe item, a lunch box, a wallet and the like), or a plurality of recess to store or place small items (for example, a pen drive, a pen, a notepad and alike) associated with the user. Moreover, the dashboard 102A of the vehicle 102 may include a supplemental restraint system (SRS), that may be realized through several known safety technologies, such as, but limited to an air bag.

The at least one seat 102B of the vehicle 102 may include a bucket seat, or a bench seat with a contoured platform designed to seat up at least one of a single person or two persons (or even more than two persons). For example, the bucket seat may be designed to accommodate single person and the bench seat may be designed to accommodate up to three persons. By way of example, but not limitation, the bucket seat may correspond to at least one of a driver seat or a passenger seat in the front cabin of the vehicle 102, and the bench seat may correspond to the passenger seat in the rear cabin of the vehicle 102. The at least one seat 102B may typically have rounded backs and may offer a variety of adjustments to fit different sized persons. The at least one seat 102B may further include a seat structure comprising a plurality of components, such as but not limited to, a pair of bracket headset holder, a head rest panel, a front panel cushion, a side frame front panel, a rear frame cushion, a top panel cushion, brackets, a regular level, or a slide adjuster. The at least one seat 102B may be placed in the front cabin space of the vehicle 102 for a purpose to accommodate the user (such as, a driver, or an operator), or the passenger to sit, or drive the vehicle 102. Moreover, the at least one seat 102B of the vehicle 102 may include the supplemental restraint system (SRS), that may be realized through several known safety technologies, such as, but not limited to a seat belt.

The foot space 102C of the vehicle 102 may include a vacant space available inside the cabin (for example, the front cabin, and the rear cabin) of the vehicle 102, typically in front of legs of the user (for example, a driver, and an operator), or the passenger. The foot space 102C available in front of legs of the user may include at least one of an acceleration pedal, a brake pedal, or a clutch pedal, to control motion of the vehicle 102. In an exemplary embodiment, the foot space 102C may be associated with the dashboard 102A of the vehicle 102, typically in the front cabin, and may be used to accommodate legs of the user or the passenger. In another exemplary embodiment, the foot space 102C may be maximum in the rear cabin of the vehicle 102, that may be used to accommodate small to medium sized items (for example, a water bottle, a food container, a bag pack, and alike), in addition to legs of the passengers.

The pivotable system 104 may include the pivot structure 104A rotatably attached about the pivot point 106. The pivotable system 104 may include suitable mechanical or pneumatic control mechanisms that may control a movement of the pivot structure 104A about the pivot point 106. In certain cases, the pivotable system 104 may be manually controlled by the user. The pivotable system 104 may be used by the user to control movement of the pivot structure 104A, in manual mode or a semi-autonomous mode. In accordance with an embodiment, the movement of the pivot structure 104A may be automatically controlled, via an electronic control unit (ECU) associated with the vehicle 102, in an autonomous mode.

The pivot structure 104A is shown to have a substantially rectangular shape, as shown in FIG. 1. However, the pivot structure 104A may also be formed with various shapes (for example, a substantially square shape, a substantially semi-circular shape, and the like). The pivot structure 104A may restrict access to the foot space 102C, to prevent at least one of carried objects falling in the foot space 102C or prevent a pet from hiding and sitting in the foot space 102C. In an embodiment, the pivot structure 104A may be made from high strength and shock absorbent materials (for example, a Polypropylene, a Polyurethane, a Polycarbonate, a Polyamideimide, and the like) to provide optimal strength to the pivot structure 104A. The pivot structure 104A may accommodate the carried objects (for example, a computing device, an eatabe item, a lunch box, a wallet and the like) in close proximity of the user or the passenger and provide an access to such objects easily while travelling.

The pivot point 106 may be configured to provide a rotational movement to the pivot structure 104A about a movement axis, which may be parallel to a lateral axis of the pivot structure 104A. The pivot point 106 may allow a rotational movement of the pivot structure 104A about a single point and therefore, may have one degree of freedom. The rotational movement about the pivot point 106 may be controlled in a manual mode or a semi-autonomous mode. In an embodiment, the movement of the pivot point 106 may be automatically controlled, via an electronic control unit (ECU) associated with the vehicle 102. In another embodiment, the movement of the pivot point 106 may be manually controlled by the user by application of resistive force to provide required rotational movement to the pivot point 106 to place the pivot structure 104A in plurality of configurations, such as, but not limited to, an open configuration, or a closed configuration.

The rotation control device 104B may include suitable logic, circuitry, interfaces, and/or code that may be configured to control the movement of the pivot structure 104A about the pivot point 106. The rotation control device 104B may be a specialized electronic circuitry that may include an electronic control unit processor to control distinct functions, such as, but not limited to, controlling the movement of the pivot structure 104A. The rotation control device 104B may be a microprocessor which may receive one or more control commands from the user to control the movement of the pivot structure 104A about the pivot point 106. By way of example, but not limitation, the rotation control device 104B may receive one or more command from an automotive dashboard, an embedded device, a smartphone, a human-machine interface (HMI), a computer workstation, a handheld computer, a cellular/mobile phone, a portable consumer electronic (CE) device, a server, and other computing devices, to control the movement of the pivot structure 104A about the pivot point 106.

The slot 108 may be provided on the dashboard 102A of the vehicle 102 to accommodate the pivot structure 104A. The slot 108 may have a substantially rectangular shape or may be formed with various shapes (for example, a substantially square shape, a substantially rectangular shape, and the like), based on shape of the pivot structure 104A. The slot 108 may be manufactured based on a dimensional aspect of the pivot structure 104A. For example, in case dimensions of the pivot structure 104A may be in a range of 120 mm to 150 mm, then the dimensions of the slot 108 may be in the range of 120 mm to 150 mm with a clearance of 1 mm to 2 mm, to ease accommodation of the pivot structure 104A into the slot 108.

In operation, the pivotable system 104 may be associated with the dashboard 102A of the vehicle 102. The pivotable system 104 may include the pivot structure 104A that may be rotatably attached to the pivot point 106 on the dashboard 102A of the vehicle 102. The pivot point 106 may be configured to provide a rotational movement to the pivot structure 104A about the movement axis which may be parallel to the lateral axis of the pivot structure 104A, to place the pivot structure 104A in plurality of configurations, such as, but not limited to, the open configuration, or the closed configuration. The movement of the pivot structure 104A about the pivot point 106 may be configured to control the access to the foot space 102C associated with the at least one seat 102B of the vehicle 102. The foot space 102C may correspond to the foot space in close proximity of the dashboard 102A in the front cabin of the vehicle 102, either on the driver side or the passenger side of the vehicle 102. Moreover, the foot space 102C, may correspond to the dashboard 102A of the vehicle 102.

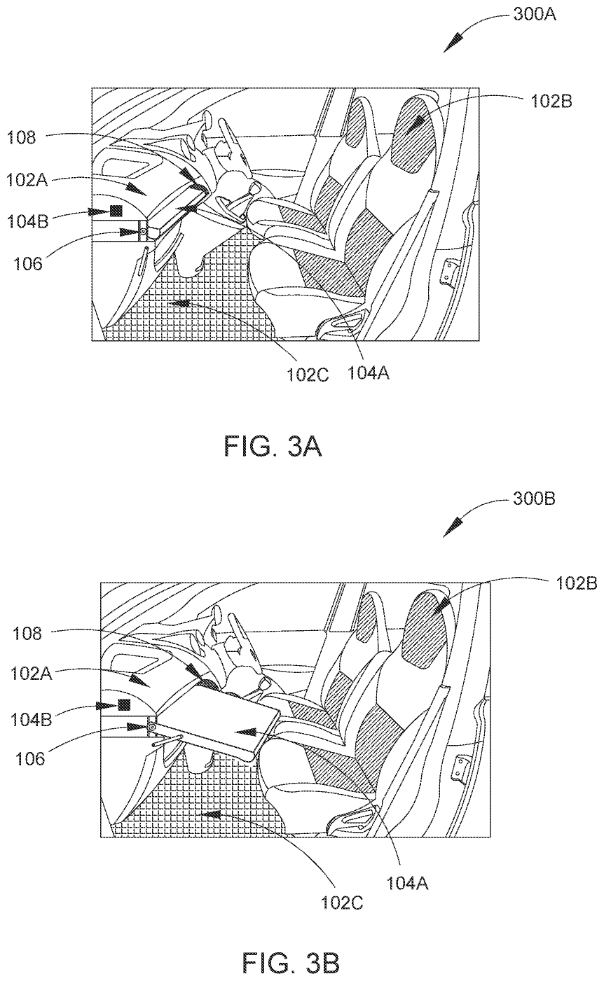

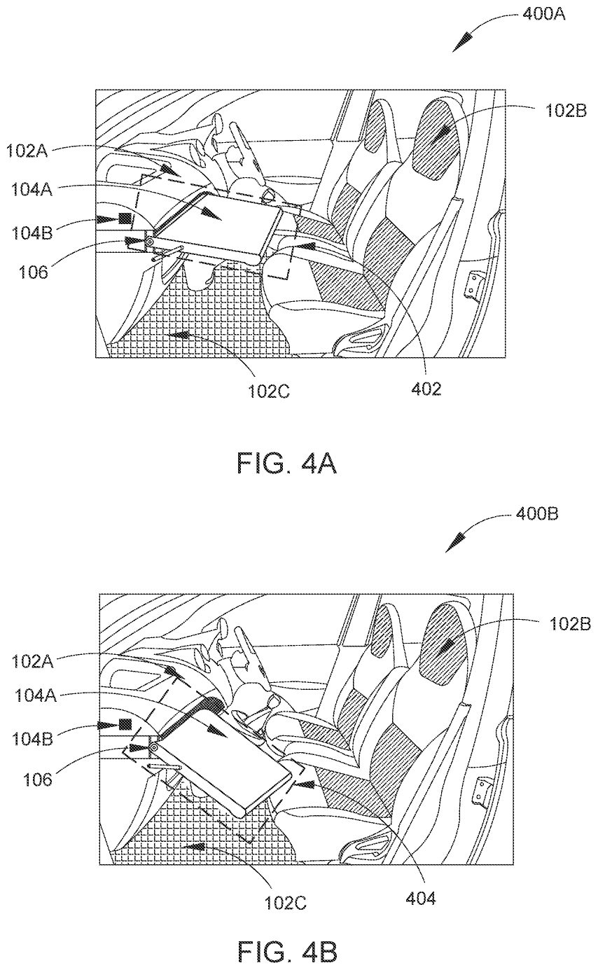

Further, the pivotable system 104 may further include the rotation control device 104B, which may be associated with the pivot point 106 on the dashboard 102A of the vehicle 102. The rotation control device 104B may be configured to control the rotation of the pivot structure 104A about the pivot point 106 to place the pivot structure 104A in the plurality of configuration, to control access in the foot space 102C. By way of example, but not limitation, in case the user may require restricting the foot space 102C, then the user may provide one or more commands to the rotation control device 104B. Accordingly, the rotation control device 104B may be configured to control the rotation of the pivot structure 104A about the pivot point 106 to place the pivot structure 104A in the closed configuration (shown in FIGS. 4 and 4B) to control access in the foot space 102C. The pivot structure 104A may be configured to restrict access to the foot space 102C, to prevent at least one of the carried objects falling in the foot space 102C or prevent the pet hiding and sitting in the foot space 102C. In an embodiment, the pivot structure 104A may be configured to accommodate the carried objects (for example, a computing device, an eatabe item, a lunch box, a wallet, and the like) in proximity of the user or the passenger, to access them quickly while travelling. Further, the rotation control device 104B may be configured to move the pivot structure 104A in one of a stowed configured or an un-stowed configuration, which is explained for example, in FIGS. 3A and 3B. Moreover, the rotation control device 104B may be configured to move the pivot structure 104A in the slot 108 of the dashboard 102A in the stowed configuration, which is explained for example, in FIGS. 3A and 3B.

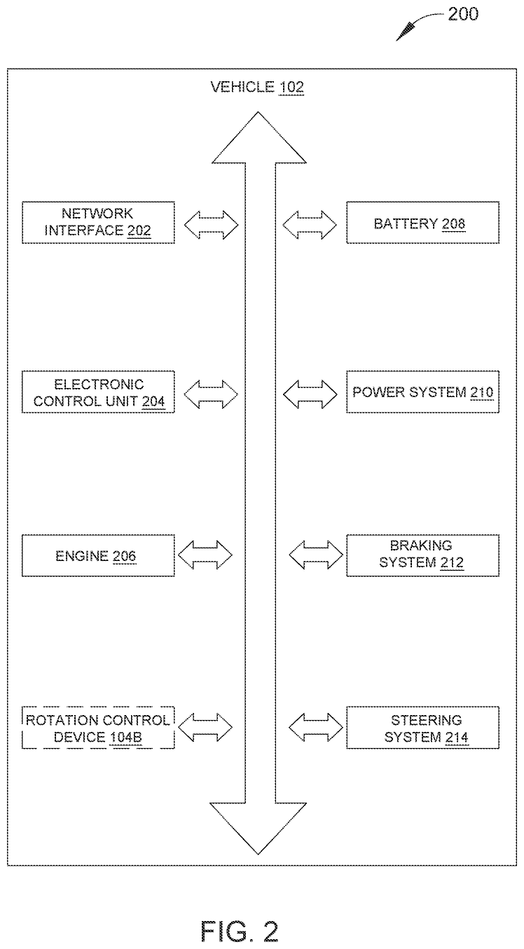

FIG. 2 is a block diagram that illustrates an exemplary vehicle system to control access to a foot space associated with a vehicle, in accordance with an embodiment of the disclosure. FIG. 2 is explained in conjunction with elements from FIG. 1. There is shown a block diagram 200 of the vehicle 102 that includes a network interface 202, an electronic control unit 204, an engine 206, the rotation control device 104B, a battery 208, a power system 210, a braking system 212, and a steering system 214.

In accordance with an embodiment, the vehicle 102 may include a control circuitry (not shown in FIG. 2), that may be configured to communicatively couple various vehicle systems (such as, but not limited to, the electronic control unit 204, the engine 206, the rotation control device 104B, the battery 208, the power system 210, the braking system 212, or the steering system 214) to a server or another electronic devices (not shown in FIG. 2), via the network interface 202. The server (or the other electronic devices) may be configured to remotely control different functions, such as, but not limited to, operation of the engine 206, the braking system 212, the steering system 214, or the rotation control device 104B. In a preferred embodiment, the network interface 202 may receive control commands from a server (or the other electronic devices) to control a movement of the pivot structure 104A, via operation of the rotation control device 104B.

The network interface 202 may include suitable logic, circuitry, and interfaces that may be configured to facilitate communication between the vehicle systems and the server, or any other device in the network environment, via a communication network (not shown in FIG. 2). The network interface 202 may be implemented by use of various known technologies to support wired or wireless communication of the vehicle systems (such as, but not limited to, the electronic control unit 204, or the rotation control device 104B), to a server or other electronic devices in the communication network. The network interface 202 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry. The network interface 202 may be configured to communicate via wireless communication with networks, such as the Internet, an Intranet, or a wireless network, such as a cellular telephone network, a wireless local area network (LAN), and a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS).

The electronic control unit 204 may include suitable logic, circuitry, interfaces, and/or code that may be configured to control operation of the rotation control device 104B. The electronic control unit 204 may be a specialized electronic circuitry that may include an electronic control unit (ECU) processor to control distinct functions, such as, but not limited to, controlling the movement of the pivot structure 104A using the rotation control device 104B. The electronic control unit 204 may be a microprocessor, which may receive one or more commands from a user (such as, a driver or an operator), to control the operation of the rotation control device 104B, that may be configured to control the movement of the pivot structure 104A about the pivot point 106. By way of example, but not limitation, the electronic control unit 204 may receive one or more commands via at least one of an automotive dashboard, an embedded device, a smartphone, a human-machine interface (HMI), a computer workstation, a handheld computer, or a cellular/mobile phone. The electronic control unit 204 may control operation of the vehicle 102. The electronic control unit 204 may be included or integrated in the vehicle 102.

The engine 206 may be configured to provide power to the vehicle 102. The engine 206 may be an internal combustion engine with may execute operations, for example, fuel injection, compression, ignition, or emission to power and drive the vehicle 102. The engine 206 may include various parts, for example, but are not limited to, a crankshaft, a cylinder, a spark plug, a piston, camshaft, a valve, combustion chamber, etc. In some embodiments, the engine 206 may include a motor in case of an electric motorcycle. The engine 206 may be two-stroke or four-stroke internal combustion engines. The engine 206 may include either one, two, three, four, or six cylinders. Examples of the engine 206 may include, but are not limited to, an inline engine (i.e. single cylinder, parallel twin, inline-triple, inline-four, inline-six), a V layout engine (i.e. V-twin engine, a V4 engine, a V8 engine), a flat (boxer) engine (i.e. flat-two, flat-four, flat-six), a lawn mower engine, a snow blower engine, or other motorcycle engines known in the art. A description of various parts of the engine 206 has been omitted from the disclosure for the sake of brevity.

The battery 208 may be a source of electric power for one or more electric circuits or loads (not shown in FIG. 2). For example, the battery 208 may be a source of electrical power to at least one of the electronic control unit 204, or the rotation control device 104B, associated with the vehicle 102. The battery 208 may be a rechargeable battery. The battery 208 may be the source of electrical power to start the engine 206 of the vehicle 102. In some embodiments, the battery 208 may correspond to a battery pack, which may have a plurality of clusters of batteries, which may be surrounded by a suitable coolant and a charge controller (not shown in FIG. 2). Examples of the battery 208 may include, but are not limited to, a lead acid battery, a nickel cadmium battery, a nickel-metal hydride battery, a lithium-ion battery, and other rechargeable batteries.

The power system 210 may include suitable logic, circuitry, interfaces, and/or code that may be configured to control electric power which may be output to various electric circuits and loads (not shown in FIG. 2) of the vehicle 102. The power system 210 may include a battery (not shown) to supply the electric power to perform various electrical operations of the vehicle 102. The power system 210 may provide the electric power for functioning of different components such as, but not limited to, the electronic control unit 204, or the rotation control device 104B associated with the vehicle 102. In an embodiment, the power system 210 may be configured to receive control signals from the network interface 202 to control operation of the rotation control device 104B. The power system 210 may be configured to control the charging and the discharging of the battery 208 based on the received control signals. Examples of the power system 210 may include, but are not limited to, an electric charge/discharge controller, a charge regulator, a battery regulator, a battery management system, an electric circuit breaker, a power electronic drive control system, an Application-Specific Integrated Circuit (ASIC) processor, and/or other energy-control hardware processors.

The braking system 212 may be used to stop or slow down the vehicle 102 by application of resistive forces, such as electromagnetic and/or frictional forces. The braking system 212 may receive a command from a powertrain control system under control of the control circuitry when the vehicle 102 is in an autonomous mode or a semi-autonomous mode. Following an embodiment, the braking system 212 may receive a command from the control circuitry, when the control circuitry preemptively detects an intent of the user to perform a specific task which requires the user to apply brakes.

The steering system 214 may receive one or more control commands from the electronic control unit 204. The steering system 214 may include a steering wheel/handlebar and/or an electric motor (provided for a power-assisted steering) that may be used by the user to control movement of the vehicle 102 in a manual mode or a semi-autonomous mode. In accordance with an embodiment, the movement or steering of the vehicle 102 may be automatically controlled when the vehicle 102 is in autonomous mode. Examples of the steering system 214 may include, but are not limited to, an autonomous steering control, a power-assisted steering system, a vacuum/hydraulic-based steering system, an electro-hydraulic power-assisted system (EHPAS), or a “steer-by-wire” system, or an autonomous steering system, known in the art.

The functions or operations executed by the rotation control device 104B, may be controlled remotely using the network interface 202, which may receive one or more control commands from the user to control the movement of the pivot structure 104A about the pivot point 106, is described in detail, for example, in FIG. 1. The description of functions or operations of the rotation control device 104B, to control movement of the pivot structure 104A about the pivot point 106 have been omitted from the disclosure of FIG. 2 for the sake of brevity.

FIGS. 3A and 3B are diagrams that collectively illustrate different configurations of a pivot structure to control access to a foot space associated with a vehicle, in accordance with an embodiment of the disclosure. FIG. 3A and 3B are explained in conjunction with elements from FIG. 1 and FIG. 2. With reference to FIG. 3A there is shown an exemplary scenario 300A that includes a stowed configuration of the pivot structure 104A. With reference to FIG. 3B there is shown another exemplary scenario 300B that includes an un-stowed configuration of the pivot structure 104A.

At 300A, the stowed configuration of the pivot structure 104A is shown. The rotation control device 104B may be configured to move the pivot structure 104A in the stowed configuration. The pivot structure 104A may be configured to be retracted in the slot 108 of the dashboard 102A of the vehicle 102 in the stowed configuration. In an exemplary embodiment, the stowed configuration may correspond to one of a stored configuration, a default configuration, or an initial configuration. By way of example, but not limitation, the user may provide one or more commands to the rotation control device 104B to retract the pivot structure 104A into the slot 108 of the dashboard 102A of the vehicle 102, in case the passenger seat is vacant, or user does not require to accommodate the carried objects. By way of another example, but not limitation, in case the engine 206 is operative, the electronic control unit 204 may control the operation of the rotation control device 104B, that may be configured to move the pivot structure 104A in the slot 108 of the dashboard 102A in the stowed configuration.

At 300B, the un-stowed configuration of the pivot structure 104A is shown. The rotation control device 104B may be configured to move the pivot structure 104A in the un-stowed configuration. The pivot structure 104A may be configured to be protracted from the dashboard 102A of the vehicle 102 in the un-stowed configuration. In an exemplary embodiment, the un-stowed configuration may correspond to one of an extended configuration, or an open configuration (shown in FIGS. 4A and 4B). By way of example, but not limitation, the user may provide one or more commands to the rotation control device 104B to protract the pivot structure 104A from the dashboard 102A of the vehicle 102, to restrict the access to the foot space 102C and/or to prevent the carried objects from falling in the foot space 102C. Moreover, the user may provide one or more commands to the rotation control device 104B to protract the pivot structure 104A from the dashboard 102A of the vehicle 102, to restrict the access to the foot space 102C to prevent a pet from hiding and sitting in the foot space 102C. By way of another example, but not limitation, the user may provide one or more commands to the rotation control device 104B to protract the pivot structure 104A from the slot 108 of the dashboard 102A of the vehicle 102 in case the user or the passenger requires to accommodate the carried objects. By way of yet another example, but not limitation, in case the engine 206 is operative, the electronic control unit 204 may control the operation of the rotation control device 104B, that may be configured to move the pivot structure 104A from the slot 108 of the dashboard 102A in the un-stowed configuration. Further, the rotation control device 104B may be configured to move the pivot structure 104A in one of an open configuration or a closed configuration, in the un-stowed configuration, described, for example, in FIGS. 4A and 4B.

It should be noted that the scenarios 300A and 300B of FIGS. 3A and 3B, respectively, are for exemplary purposes and should not be construed to limit the scope of the disclosure.

FIGS. 4A and 4B are scenario diagrams that collectively illustrate configuration of a pivot structure in an un-stowed configuration to control access to a foot space associated with a vehicle, in accordance with an embodiment of the disclosure. FIGS. 4A and 4B are explained in conjunction with elements from FIG. 1, FIG. 2, and FIGS. 3A and 3B. With reference to FIG. 4A, there is shown an exemplary scenario 400A that includes an open configuration 402 that may correspond to a horizontal orientation of the pivot structure 104A. With reference to FIG. 4B, there is shown another exemplary scenario 400B that includes a closed configuration 404 that may correspond to an inclined orientation of the pivot structure 104A.

In accordance with FIG. 4A, the open configuration 402 of the pivot structure 104A is shown. The rotation control device 104B may be configured to move the pivot structure 104A in the open configuration 402, when the pivot structure 104A may be in the un-stowed configuration. The rotation control device 104B may be configured to move the pivot structure 104A in a horizontal orientation with respect to the at least one seat 102B of the vehicle. Further, in the open configuration 402, the foot space 102C may be accessible to the user or the passenger. The foot space 102C in the open configuration 402 may be configured to accommodate legs of the passenger sitting on a passenger seat of the vehicle 102. By way of example, but not limitation, the foot space 102C in the open configuration 402 may be used to accommodate small to medium sized items (for example, a water bottle, a food container, a bag pack, and alike). By way of another example, but not limitation, in case the user or the passenger requires to accommodate the carried objects in proximity while travelling, then the user or the passenger may use the pivot structure 104A in the open configuration 402. For example, if the user requires an accommodation of a food item, to be consumed while driving the vehicle 102, then the user may use the pivot structure 104A in the horizontal orientation.

In accordance with FIG. 4B, the closed configuration 404 of the pivot structure 104A is shown. The rotation control device 104B may be configured to move the pivot structure 104A in the closed configuration 404, when the pivot structure 104A may be in the un-stowed configuration. The rotation control device 104B may be configured to move the pivot structure 104A in the inclined orientation with respect to the at least one seat 102B of the vehicle 102. The inclined orientation may correspond to the closed configuration 404. Further, in the closed configuration 404, the foot space 102C may be inaccessible to the user or the passenger. The foot space 102C in the closed configuration 404 may be configured to prevent the carried objects from falling in the foot space 102C. Moreover, the pivot structure 104A in the closed configuration 404 may be configured to prevent a pet from hiding and sitting in the foot space 102C. In an embodiment, the rotation control device 104B may be configured to move the pivot structure 104A from the closed configuration 404 to the open configuration 402, to provide access to the foot space 102C, when the passenger boards the passenger seat of the vehicle 102. Also, in case, the passenger seat (e.g., the at least one seat 102B) is empty and/or carried objects or pets are present on the passenger seat (e.g., the at least one seat 102B), the rotation control device 104B may be configured to move the pivot structure 104A from the closed configuration 404 to the open configuration 402. The movement of the pivot structure 104A from the open configuration 402 to the closed configuration 404 may restrict an access to the foot space 102C of the vehicle 102.

It should be noted that the scenarios 400A and 400B of FIGS. 4A and 4B, respectively, are for exemplary purposes and should not be construed to limit the scope of the disclosure.

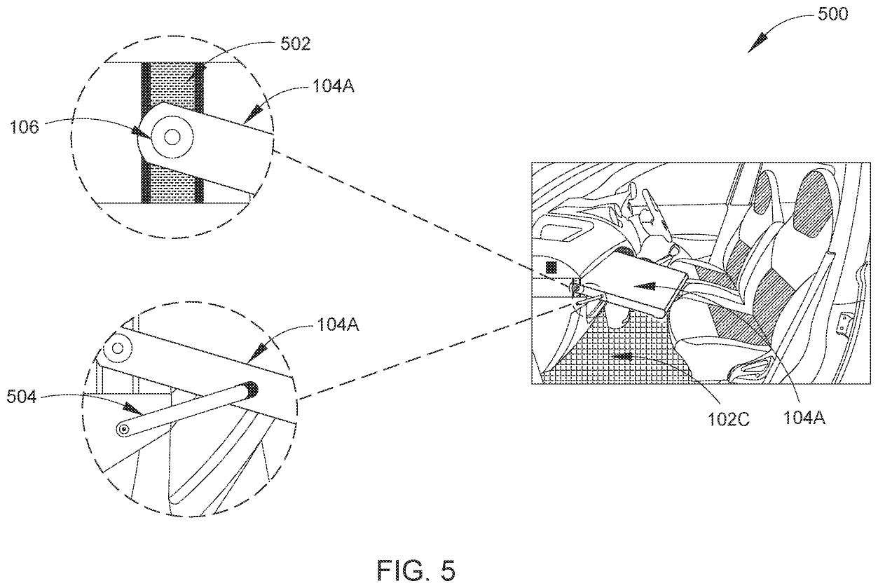

FIG. 5 is an exemplary scenario diagram that illustrates a height adjustment and a locking mechanism associated with a pivot structure, in accordance with an embodiment of the disclosure. FIG. 5 is explained in conjunction with elements from FIG. 1, FIG. 2, FIGS. 3A and 3B, and FIGS. 4A and 4B. With reference to FIG. 5, there is shown a scenario 500 that may be illustrated as implementation of two scenarios including a height adjustment mechanism 502, and a locking mechanism 504.

In first implementation, the pivot structure 104A may further include the height adjustment mechanism 502, that may be configured to adjust a height of the pivot structure 104A with respect to the at least one seat 102B of the vehicle 102. The height adjustment mechanism 502 may be configured to adjust the height of the pivot structure 104A to accommodate different sized users or passengers on the at least one seat 102B. In an embodiment, the height adjustment mechanism 502 may include a driving mechanism configured to drive and lock the pivot structure 104A to different heights based on a size of the user or passenger sitting on the at least one seat 102B. The drive mechanism may be operated by at least one of a hydraulic mechanism, a pneumatic mechanism, a slider and roller mechanism, or a gear to raise or lower the pivot structure 104A to different heights. In another embodiment, the height adjustment mechanism 502 may include one or more arms having a vertical adjustment mechanism to automatically drive and lock the pivot structure 104A to different heights. The vertical adjustment mechanism may include a rotating member, such as, but not limited to, a ball screw and ball nut assembly. In yet another embodiment, the height adjustment mechanism 502 may include a scissor mechanism that may be operated using at least one of a hydraulic mechanism, or a pneumatic mechanism to drive and lock the pivot structure 104A to different heights.

In an embodiment, the pivot structure 104A may further include the locking mechanism 504, that may be configured to restrict movement of the pivot structure 104A in the open configuration (shown in FIG. 4A). The locking mechanism 504 may be configured to restrict or block movement of the pivot structure 104A, when subjected to reactive loading, sudden jerk or vibration, in the open configuration 402. The locking mechanism 504 may be configured to lock the pivot structure 104A in the open configuration 402, to prevent the carried objects falling in the foot space 102C, in case, the carried objects are placed over the pivotable system 104. In an embodiment, the locking mechanism 504 may include a mechanical linkage coupled between the pivot structure 104A and the dashboard 102A of the vehicle 102. The linkage may include an actuator that may provide assistance in coupling or uncoupling the pivot structure 104A with the dashboard 102A. The actuator may be operated by at least one of a hydraulic mechanism, or a pneumatic mechanism, to actuate the mechanical linkage to lock the pivot structure 104A in the open configuration 402 with respect to the dashboard 102A of the vehicle 102. In another embodiment, the locking mechanism 504 may include an arm screwed in between the pivot structure 104A and the dashboard 102A using a rotating element, such as, but not limited to, a ball and socket joint, a screw, or a ball nut assembly.

It should be noted that the scenario 500 of FIG. 5 is for exemplary purposes and should not be construed to limit the scope of the disclosure.

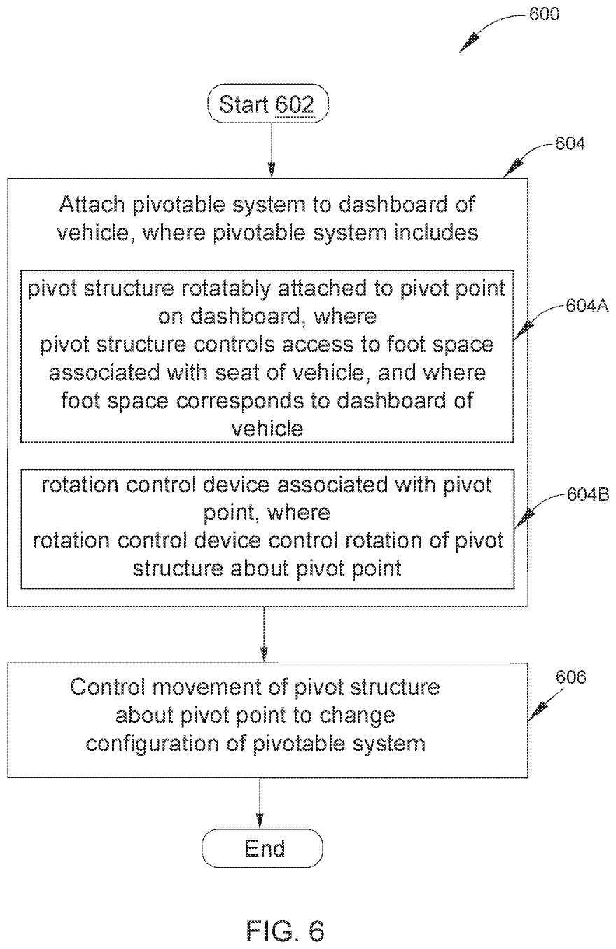

FIG. 6 is a flowchart that illustrates an exemplary method to control access to a foot space associated with a vehicle, in accordance with an embodiment of the disclosure. FIG. 6 is explained in conjunction with elements from FIG. 1, FIG. 2, FIGS. 3A and 3B, FIGS. 4A and 4B, and FIG. 5. There is shown a flowchart 600, which may depict exemplary operations that are performed by an exemplary system, such as the pivotable system 104 of FIG. 1 or any suitable system, apparatus, or device. The method illustrated in the flowchart 600 may start at 602 and proceed to 604.

At 604, the pivotable system 104 may be attached to the dashboard 102A of the vehicle 102. In one or more embodiments, a processor (e.g., the electronic control unit 204) may be configured to enable an attachment of the pivotable system 104 to the dashboard 102A of the vehicle 102. For example, the processor may enable attachment of the pivotable system 104 to the dashboard 102A by connecting the rotation control device 104B to the control circuitry of the vehicle 102. Based on the connection of the rotation control device 104B to the control circuitry, the rotation control device 104B may receive power from one of the battery 208, the engine 206, or the power system 210 of the vehicle 102. Further, based on the connection of the rotation control device 104B, the electronic control unit 204 may be configured to control the rotation control device 104B and thereby control the operation of the pivotable system 104.

As shown in 604A, the pivotable system 104 may include the rotatably attachable pivot structure 104A that may be attached to the pivot point 106 on the dashboard 102A, to control access to the foot space 102C associated with the vehicle 102.

As shown in 604B, the pivotable system 104 may further be configured to control rotation of the pivot structure 104A about the pivot point 106 using the rotation control device 104B associated with the pivot point 106 on the dashboard 102A of the vehicle 102, as further described, for example, in FIG. 1, FIG. 2, FIGS. 3A and 3B, and FIGS. 4A and 4B.

At 606, a movement of pivot structure 104A about the pivot point 106 may be controlled to change a configuration of the pivotable system 104. In one or more embodiments, the rotation control device 104B may be configured to control movement of the pivot structure 104A about the pivot point 106 to change configuration of the pivotable system 104. For example, the configuration of the pivotable system 104 may include at least one of a stowed configuration or an un-stowed configuration. The pivot structure 104A may be configured to be retracted to the dashboard 102A in the stowed configuration and protracted from the dashboard in the un-stowed configuration. Also, when the pivot structure 104A is in the un-stowed configuration, the pivot structure 104A may be configured to be in one of an open configuration or a closed configuration. Herein, the foot space 102C may be accessible in the open configuration and inaccessible in the closed configuration. The control of movement of the pivot structure 104A is further described, for example, in FIG. 1, FIG. 2, FIGS. 3A and 3B, and FIGS. 4A and 4B. Control may pass to end.

Although the flowchart 600 is illustrated as discrete operations, such as 602, 604, and 606, the disclosure is not so limited. Accordingly, in certain embodiments, such discrete operations may be further divided into additional operations, combined into fewer operations, or eliminated, depending on the particular implementation without detracting from the essence of the disclosed embodiments.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also, to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

The foregoing description of embodiments and examples has been presented for purposes of illustration and description. It is not intended to be exhaustive or limiting to the forms described. Numerous modifications are possible considering the above teachings. Some of those modifications have been discussed and others will be understood by those skilled in the art. The embodiments were chosen and described for illustration of various embodiments. The scope is, of course, not limited to the examples or embodiments set forth herein but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. A pivotable system associated with a dashboard of a vehicle, the pivotable system comprising:
a pivot structure rotatably attached to a pivot point on the dashboard of the vehicle, wherein
the pivot structure is configured to control an access to a foot space associated with at least one seat of the vehicle, and
the foot space corresponds to the dashboard of the vehicle; and
a rotation control device associated with the pivot point on the dashboard of the vehicle, wherein
the rotation control device is configured to control a rotation of the pivot structure about the pivot point.

2. The pivotable system according to claim 1, wherein the rotation control device is configured to move the pivot structure in one of a stowed configuration or an un-stowed configuration.

3. The pivotable system according to claim 2, wherein the pivot structure is configured to be retracted to the dashboard in the stowed configuration and protracted from the dashboard in the un-stowed configuration.

4. The pivotable system according to claim 2, wherein the pivot structure is stowed in a slot of the dashboard in the stowed configuration.

5. The pivotable system according to claim 2, wherein when the pivot structure is in the un-stowed configuration, the pivot structure is configured to be in one of an open configuration or a closed configuration.

6. The pivotable system according to claim 5, wherein the foot space being accessible in the open configuration and inaccessible in the closed configuration.

7. The pivotable system according to claim 5, wherein
the rotation control device is further configured to move the pivot structure in one of a horizontal orientation or an inclined orientation with respect to the at least one seat, and
the horizontal orientation corresponds to the open configuration and the inclined orientation corresponds to the closed configuration.

8. The pivotable system according to claim 5, wherein the pivot structure further includes a locking mechanism configured to restrict movement of the pivot structure in the opened configuration.

9. The pivotable system according to claim 1, wherein the pivot structure further includes a height adjustment mechanism configured to adjust a height of the pivot structure with respect to the at least one seat.

10. A vehicle including:
a cabin including:
a dashboard,
at least one seat,
a foot space associated with the at least one seat, and
a pivotable system including:
a pivot structure rotatably attached to a pivot point on the dashboard of the vehicle, wherein
the pivot structure is configured to control an access to a foot space associated with the at least one seat of the vehicle,
the foot space corresponds to the dashboard of the vehicle; and
a rotation control device associated with the pivot point on the dashboard of the vehicle, wherein
the rotation control device is configured to control a rotation of the pivot structure about the pivot point.

11. The vehicle according to claim 10, wherein the rotation control device is configured to move the pivot structure in one of a stowed configuration or an un-stowed configuration.

12. The vehicle according to claim 11, wherein the pivot structure is configured to be retracted to the dashboard in the stowed configuration and protracted from the dashboard in the un-stowed configuration.

13. The vehicle according to claim 11, wherein the pivot structure is stowed in a slot of the dashboard in the stowed configuration.

14. The vehicle according to claim 11, wherein when the pivot structure is in the un-stowed configuration, the pivot structure is configured to be in one of an open configuration or a closed configuration.

15. The vehicle according to claim 14, wherein the foot space being accessible in the open configuration and inaccessible in the closed configuration.

16. The vehicle according to claim 14, wherein
the rotation control device is further configured to move the pivot structure in one of a horizontal orientation or an inclined orientation with respect to the at least one seat, and
the horizontal orientation corresponds to the open configuration and the inclined orientation corresponds to the closed configuration.

17. The vehicle according to claim 14, wherein the pivot structure further includes a locking mechanism configured to restrict movement of the pivot structure in the opened configuration.

18. The vehicle according to claim 10, wherein the pivot structure further includes a height adjustment mechanism configured to adjust a height of the pivot structure with respect to the at least one seat.

19. A method, making up:
in a vehicle:
attaching a pivotable system to a dashboard of the vehicle, wherein the pivotable system includes:
a pivot structure rotatably attached to a pivot point on the dashboard, wherein
the pivot structure is configured to control an access to a foot space associated with at least one seat of the vehicle, and
the foot space corresponds to the dashboard of the vehicle, and
a rotation control device associated with the pivot point on the dashboard of the vehicle, wherein
the rotation control device is configured to control a rotation of the pivot structure about the pivot point; and
controlling a movement of the pivot structure about the pivot point to change a configuration of the pivotable system.

20. The method according to claim 19, wherein
the configuration of the pivotable system includes at least one of a stowed configuration or an un-stowed configuration,
the pivot structure is configured to be retracted to the dashboard in the stowed configuration and protracted from the dashboard in the un-stowed configuration,
when the pivot structure is in the un-stowed configuration, the pivot structure is configured to be in one of an open configuration or a closed configuration, and
the foot space being accessible in the open configuration and inaccessible in the closed configuration.
